(19) United States
(12) Patent Application Publication
(10) Pub. No.: US 2010/0239084 A1
(43) Pub. Date: Sep. 23, 2010

(54) Memorable Telephone Number Identification

(75) Inventors: Elizabeth A. Brown, Woodinville, WA (US); Jeremy D. Brown, Woodinville, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/405,581

(22) Filed: Mar. 17, 2009

(51) Int. Cl. H04M 3/42

(52) U.S. Cl. 379/218.01

(57) ABSTRACT

A computing device includes a processing unit and a system memory connected to the processing unit. The system memory includes instructions that, when executed by the processing unit, cause the processing unit to: retrieve a pool of telephone numbers; analyze repeating digits and perform pattern matching for each number in the pool of telephone numbers; associate a memorability score with one or more of the numbers in the pool of telephone numbers; and sort the pool of telephone numbers based on the memorability score to create a sorted list of numbers.

### BACKGROUND

Telephone lines are primary contact points for many individuals and businesses. Therefore, it can be important to have a number that is easy to memorize. Some businesses and individuals obtain “vanity numbers” from telecommunications companies so that their telephone numbers are easier to remember. Vanity numbers allow individuals to remember words, rather than numbers. For example, the vanity number associated with MICROSOFT® ZUNE® Support is 877-438-9863, which is more easily remembered as 877-GET-ZUNE. Because vanity numbers are desirable and limited in quantity, telecommunications companies often charge a premium to obtain them.

### SUMMARY

In one aspect, a computing device includes a processing unit and a system memory connected to the processing unit. The system memory includes instructions that, when executed by the processing unit, cause the processing unit to: retrieve a pool of telephone numbers; analyze repeating digits and perform pattern matching for each number in the pool of telephone numbers; associate a memorability score with one or more of the numbers in the pool of telephone numbers; and sort the pool of telephone numbers based on the memorability score to create a sorted list of numbers.

In another aspect, a computer-implemented method for identifying memorable numbers in a pool of telephone numbers includes: retrieving, at a computing device, a pool of telephone numbers; analyzing, using the computing device, each number in the pool of telephone numbers to determine whether or not each number is memorable; associating a score with one or more of the numbers in the pool of telephone numbers, the score indicating a memorability of the numbers; and sorting, at the computing device, the pool of telephone numbers based on the score to create a sorted list of numbers.

In yet another aspect, a computer-implemented method for identifying memorable numbers in a pool of telephone numbers includes: retrieving, at a computing device, a pool of telephone numbers from a master pool of numbers; storing, at the computing device, the pool of telephone numbers in a temporary pool of numbers; analyzing, using the computing device, each number in the temporary pool of telephone numbers to determine whether or not each number is memorable, including: counting repeating digits for each number in the pool of telephone numbers; and performing pattern matching to identify relative patterns of digits in each number in the pool of telephone numbers; associating a score with each of the numbers in the pool of telephone numbers, with a higher score indicating a greater memorability and a lower score indicating a lesser memorability for the numbers; removing, at the computing device, those numbers with a score below a threshold value; sorting, at the computing device, the pool of telephone numbers based on the score for each of the numbers in the pool of telephone numbers to create a sorted list of numbers; presenting the sorted list of numbers to a user at a remote computing device; and receiving, at the computing device, a selection by the user of one or more of the telephone numbers in the sorted list of numbers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

FIG. 1 shows an example system for identifying memorable telephone numbers.

FIG. 2 shows an example server of the system of FIG. 1.

FIG. 3 shows an example pre-processing module of the server of FIG. 2.

FIG. 4 shows an example master telephone pool retrieval module of the server of FIG. 2.

FIG. 5 shows an example preliminary score processing module of the server of FIG. 2.

FIG. 6 shows an example final score processing module of the server of FIG. 2.

FIG. 7 shows an example post-processing module of the server of FIG. 2.

FIG. 8 shows an example master pool and statistical information updating module of the server of FIG. 2.

FIG. 9 shows an example embodiment of the telephone number selection graphical user interface.

FIG. 10 shows another example embodiment of the telephone number selection graphical user interface of FIG. 8 displaying a sorted telephone number list.

FIG. 11 shows a flowchart of an example method for selecting memorable telephone numbers.

FIG. 12 shows a flowchart with additional details on the method shown in FIG. 11 related to presenting the memorable telephone numbers to the user.

### DETAILED DESCRIPTION

The present application is directed to systems and methods for identifying memorable telephone numbers. In example embodiments, computers are used to automate the selection of the memorable telephone numbers.

In the examples described herein, a memorable telephone number is a telephone number with a repeating sequence of numbers (e.g., with less unique numbers and/or with repeating patterns) that is easier to remember than that of a random series of numbers. For example, a telephone number such as 555-111-1212 is more memorable than a number such as 549-893-9247.

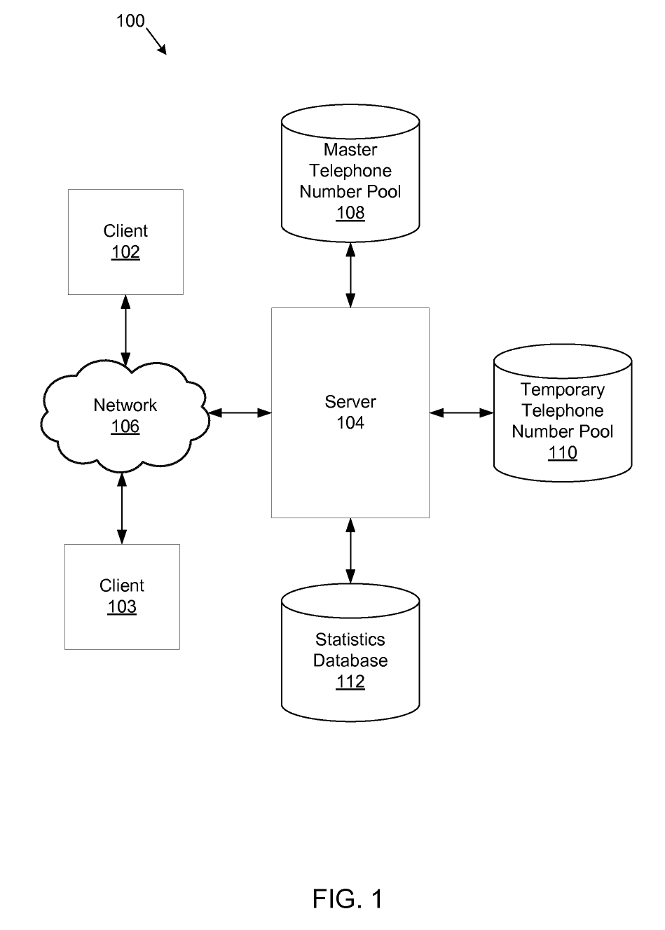

Referring now to FIG. 1, an example system 100 for identifying and providing memorable telephone numbers is shown. The system 100 includes clients 102, 103, a server 104, a network 106, a master telephone number pool 108, a temporary telephone number pool 110, and a statistics database 112. More or fewer clients, servers, networks, pools, and databases can be used. For example, the number pools and databases can be stored on separate servers, or stored on the server 104.

In example embodiments, each of the clients 102, 103 is a computing device, such as a desktop computer, a laptop computer, a netbook computer, a terminal computer, a personal data assistant, a cellular telephone, or a smart phone device. The client 102 is described below. The client 103 is configured in a similar manner.

The server 104 is accessible to the client 102 through the network 106. In example embodiments, the network 106 is the Internet, and the client 102 can access the server 104 and resources connected to the server 104 remotely. For example, as described further below, a user can utilize the client 102 to connect to the server 104 to select a telephone number. In other examples, the network 106 can be a local area network or a wide area network.

In one example, the server 104 is a computing device that includes input/output devices, a central processing unit (“CPU”), a data storage device, and a network device. The example server 104 typically includes at least one processing unit and system memory.

The system memory typically includes an operating system suitable for controlling the operation of a networked personal computer, such as the WINDOWS® operating systems from Microsoft Corporation of Redmond, Wash. or a server, such as WINDOWS SERVER® 2008 operating system, also from Microsoft Corporation of Redmond, Wash. The system memory may also include one or more software applications and may include program data.

Depending on the configuration and type of computing device, the system memory can be volatile (such as RAM), non-volatile (such as ROM, flash memory, etc.) or some combination of the two. The server can include additional data storage devices such as a computer readable storage media (removable and/or non-removable) including, for example, magnetic disks, optical disks, or tape. Computer readable storage media can include volatile and nonvolatile, removable and non-removable media implemented in any method or technology for storage of information, such as computer readable instructions, data structures, program modules, or other data. System memory, removable storage, and non-removable storage are all examples of computer readable storage media. Computer readable storage media includes, but is not limited to, RAM, ROM, EEPROM, flash memory or other memory technology, CD, DVD, Blu-Ray or other optical storage media, magnetic cassettes, magnetic tape, or other magnetic storage devices, or any other medium which can be used to store the desired information and which can be accessed by the server 104. Any such computer storage media may be part of the server 104. The server 104 may also have input device(s) such as a keyboard, mouse, pen, camera, voice input device, touch input device, etc. Output device(s) such as a display, speakers, printer, etc. may also be included.

The server 104 also contains communication connections that allow the device to communicate with other computing devices (e.g., the client 102) over a network, such as the network 106, in a distributed computing environment, for example, an intranet or the Internet. A communication connection is an example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media. The term computer readable media as used herein includes both storage media and communication media.

The client 102 can also be a computing device that is configured in a manner similar to that of the server 104 described above.

Referring still to FIG. 1, the master telephone number pool 108 is a data store that contains a list of all of the telephone numbers currently available for selection by users of the system 100. The numbers in the master telephone number pool 108 are typically acquired by the operator of the system 100 and available for purchase and use by the user of the system 100 through the client 102.

The server 104 retrieves a list including a portion or all of the available telephone numbers from the master telephone number pool 108. The list of telephone numbers is stored in the temporary telephone number pool 110. As described further below, the server 104 performs a series of operations to analyze and score the telephone numbers stored in the temporary telephone number pool 110. The scored telephone numbers are then presented to the user of the client 102 in a list from the most memorable number to the least memorable number based on the scores.

If the user selects and purchases one of the telephone numbers stored in the temporary telephone number pool 110, the server 104 updates the master telephone number pool 108 by removing the purchased telephone number from the list of available numbers. In particular embodiments, the system 100 includes more than one temporary telephone number pool 110 that can be used to perform memorable telephone number selection for more than one user simultaneously through multiple clients.

In addition, the example server 104 can collect statistics regarding how the user interacts with the system 100 through the client 102. These statistics are stored in the statistics database 112. These statistics can be used to track interactions with the system 100. In example embodiments, the statistics database 112 tracks how often the telephone number with the highest score in the list of sorted telephone numbers is chosen by the user. Some embodiments of statistics database 112 track how often the user selects a telephone number in the first sorted list displayed to the user and how many times the user requests more numbers.

As described further below, the statistics that are stored in the statistics database 112 can be used to track the state of the system 100. For example, if users consistently request multiple lists of numbers or fail to choose numbers from the lists, this can be an indication that the master pool of numbers has been depleted of desirable memorable numbers. A new master pool can thereupon be obtained to address this issue.

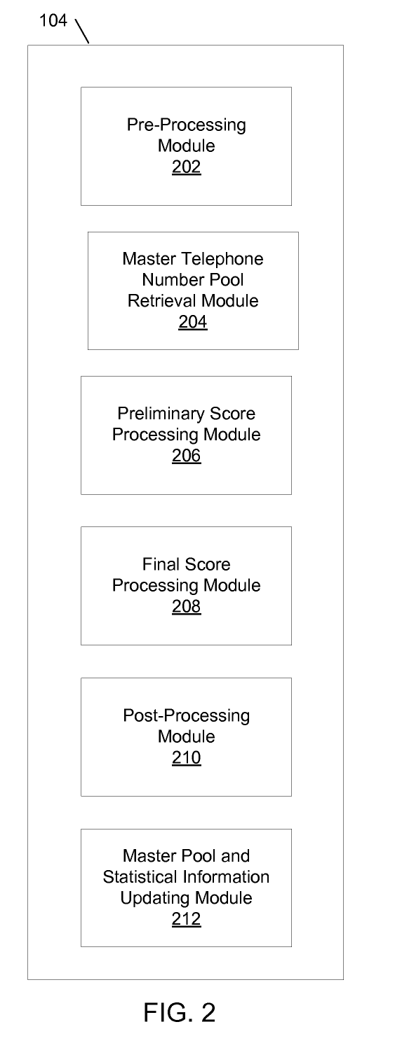

FIG. 2 shows a detailed view of the server 104. The server 104 includes a pre-processing module 202, a master telephone number pool retrieval module 204, a preliminary score processing module 206, a final score processing module 208, a post-processing module 210, and a master pool and statistical information updating module 212. In example embodiments, these are logical modules that perform operations that can be combined with or separated from other modules as desired, and the modules can be spread across one or multiple servers.

Pre-processing module 202 requests and receives user input and reduces the list of numbers in the temporary telephone number pool 110 based on the user input.

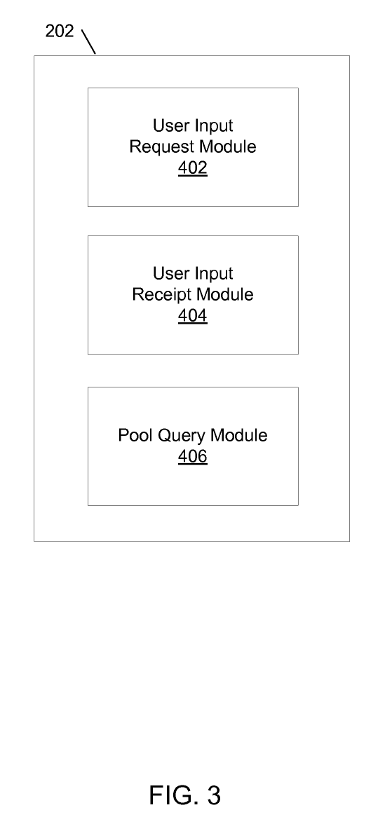

FIG. 3 shows the pre-processing module 202 of FIG. 2 in further detail. The pre-processing module 202 includes a user input request module 402, a user input receipt module 404, and a pool query module 406.

The user input request module 402 sends a request for user input of information to the client 102. In example embodiments, the user input request module 402 sends requests to the client 102 regarding the type of phone number desired by the user. In some embodiments, these include a request for the type of telephone number the user wants, such as nationwide toll free telephone number or a geographic-specific local telephone number. For example, in some embodiments, the user input request module 402 sends a request asking for the desired local area code or the desired location of the area code based on the city, state, and/or ZIP code.

The user input receipt module 404 receives the user's responses from the client 102. In example embodiments, the user input receipt module 404 can receive responses to the requests sent by the user input request module 402 relating to the type of phone number desired by the user, an area code desired by the user, or a desired city, state, and/or ZIP code in which to find a telephone number.

The pool query module 406 prepares a query that can be run against the master telephone number pool 108 to identify a subset of telephone numbers that meet the user's desired criteria. For example, if the user requests a toll free number in response to a request from the user input request module 402 for the desired type of telephone number, the pool query module 406 develops a query that will return toll free numbers. Similarly, if the user requests a local number in response to the request for the type of telephone number by the user input request module 402, the pool query module 406 develops a query that will return relevant local numbers. Further, if the user requests a telephone number from a particular area code, city, state, and/or zip code, the pool query module 406 develops a query that will return telephone numbers within the particular area code, city, state, and/or zip code requested by the user.

Once the query is formed, the query is provided to the mater telephone number pool retrieval module 202 shown in FIG. 2.

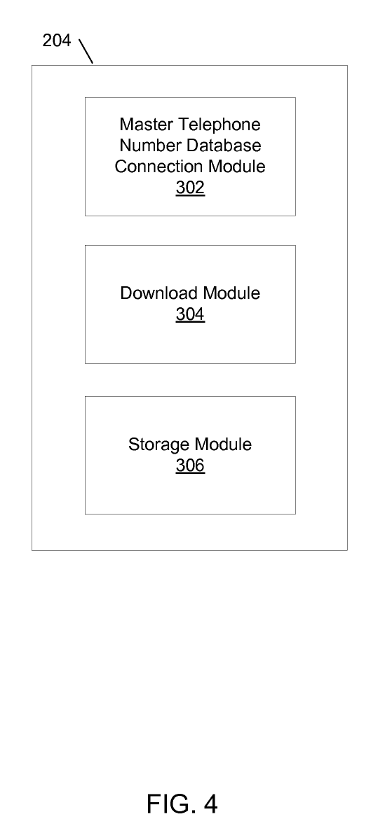

Referring now to FIG. 4, the master telephone number pool retrieval module 204 is shown in further detail. The master telephone number pool retrieval module 204 includes a connection module 302, a download module 304, and a storage module 306.

The connection module 302 connects the server 104 to the master telephone number pool 108. The master telephone number pool 108 contains the list of the telephone numbers currently available to be selected by users of the system 100. The master telephone number pool 108 is typically stored in the form of a database or a spreadsheet and can be stored in a format accessible by MICROSOFT OFFICE ACCESS® database software, MICROSOFT OFFICE EXCEL® spreadsheet software, or MICROSOFT SQL SERVER® database software from Microsoft Corporation of Redmond, Wash. Any other suitable list, database, or spreadsheet can be used, such as MICROSOFT SHAREPOINT® services from Microsoft Corporation of Redmond, Wash., LOTUS® database software from International Business Machines Corporation of Armonk, N.Y., ORACLE® database from Oracle Corporation of Redwood Shores, Calif., MYSQL® database software from MySQL AB and Sun Microsystems of Santa Clara, Calif., or a simple XML, HTML, or text file.

The download module 304 sends the query formed by the pool query module 406 to the master telephone number pool 108 and downloads a list of currently available telephone numbers that meet the desired criteria from the master telephone number pool 108 to the server 104.

The storage module 306 thereupon stores the list of currently available telephone numbers downloaded by download module 304 into the temporary telephone number pool 110. The temporary telephone number pool 110 can be a database or other data store on the server 104 or can be located remotely on a different server. The available telephone numbers stored in the temporary telephone number pool 110 are manipulated by the server 104, as discussed below, to identify memorable telephone numbers.

Referring back to FIG. 2, the preliminary score processing module 206 creates a preliminary score for each of the telephone numbers in the temporary telephone number pool 110.

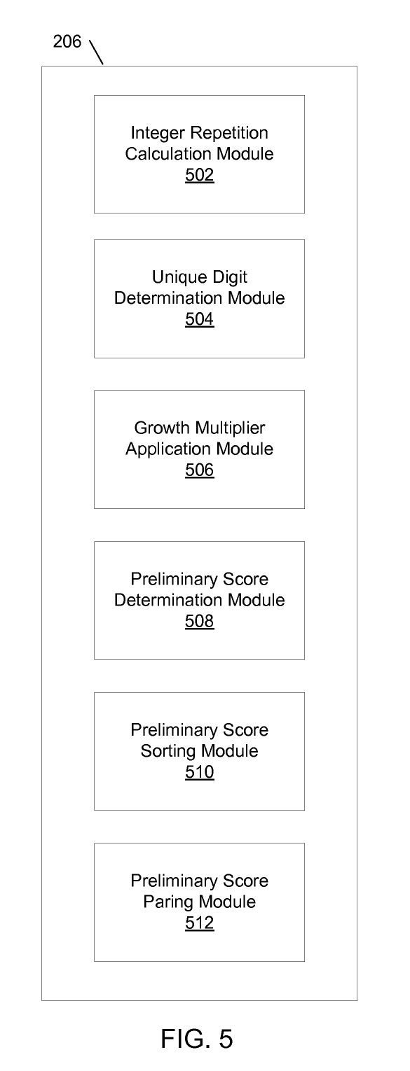

FIG. 5 shows the preliminary score processing module 206 of FIG. 2 in further detail. The preliminary score processing module 206 includes an integer repetition calculation module 502, a unique integer determination module 504, a growth multiplier application module 506, a preliminary score determination module 508, a preliminary score sorting module 510, and a preliminary score paring module 512.

The integer repetition calculation module 502 counts and stores the number of times that each integer 0-9 is found in each telephone number stored in the temporary telephone number pool 110. The unique integer determination module 504 determines the number of unique integers found in each telephone number stored in the temporary telephone number pool 110.

The growing multiplier application module 506 associates a growing multiplier to the number of times each integer 0-9 is found in each telephone number stored in temporary telephone number pool 110. In the example shown, when a single integer only repeats once, it is not weighted as heavily as a single integer that repeats multiple times.

In example embodiments, an exponentially growth multiplier is used, such that an integer occurring once in a specific telephone number receives a 1× multiplier, an integer occurring twice in a specific telephone number receives a 2× multiplier, and an integer occurring three times receives a 3× multiplier. The first three occurrence amounts are matched occurrence to multiplier, but the subsequent occurrence amounts show the exponential growing multiplier. An integer occurring four times receives a 5× multiplier, an integer occurring five times receives an 8× multiplier, an integer occurring six times receives a 10× multiplier, and an integer occurring seven times receives a 12× multiplier. Other configurations are possible.

The preliminary score determination module 508 calculates a preliminary score for each telephone number in the temporary telephone number pool 110. Specifically, the preliminary score determination module 508 multiplies the number of times each integer in each number occurs by the growth multiplier associated with the number of occurrences to get a weighted integer score for the particular integer. Then, the preliminary score determination module 508 sums all the weighted integer scores together into a preliminary score for each telephone number in the temporary telephone number pool 110. Thus, the equation for the total score of a telephone number is:

$$SCORE = ( \# of 0 s ) \times ( 0 s Multiplier ) + ( \# of 1 s ) \times ( 1 s Multiplier ) + ( \# of 2 s ) \times ( 2 s Multiplier ) + ( \# of 3 s ) \times ( 3 s Multiplier ) + ( \# of 4 s ) \times ( 4 s Multiplier ) + ( \# of 5 s ) \times ( 5 s Multiplier ) + ( \# of 6 s ) \times ( 6 s Multiplier ) + ( \# of 7 s ) \times ( 7 s Multiplier ) + ( \# of 8 s ) \times ( 8 s Multiplier ) + ( \# of 9 s ) \times ( 9 s Multiplier ) .$$

Applying this equation to the number 512-555-1212 using the example multiplier values discussed above, produces the following equation:

SCORE=(0)×(0)+(0)×(0)+(3)×(3)+(3)×(3)+(0)×(0)+(0)×(0)+(4)×(5)+(0)×(0)+(0)×(0)+(0)×(0)=38.

Applying the equation to the number 206-706-2656 using the example multiplier values discussed above, produces the following equation:

SCORE=(2)×(2)+(0)×(0)+(2)×(2)+(0)×(0)+(0)×(0)+(1)×(1)+(4)×(5)+(1)×(1)+(0)×(0)+(0)×(0)=30.

Applying the equation to the number 412-783-6783 using the example multiplier values discussed above, produces the following equation:

SCORE=(0)×(0)+(1)×(1)+(1)×(1)+(2)×(2)+(1)×(1)+(0)×(0)+(1)×(1)+(2)×(2)+(2)×(2)+(0)×(0)=16.

Applying the equation to the number 425-894-5833 using the example multiplier values discussed above, produces the following equation:

SCORE=(0)×(0)+(0)×(0)+(1)×(1)+(2)×(2)+(2)×(2)+(2)×(2)+(0)×(0)+(0)×(0)+(2)×(2)+(1)×(1)=18.

Applying the equation to the number 877-438-9863 (877-GET-ZUNE) using the example multiplier values discussed above, produces the following equation:

SCORE=(0)×(0)+(0)×(0)+(0)×(0)+(2)×(2)+(1)×(1)+(0)×(0)+(1)×(1)+(2)×(2)+(3)×(3)+(1)×(1)=20.

The preliminary score sorting module 510 sorts the telephone numbers in the temporary telephone number pool 110 by their score, in a descending fashion from highest score to lowest score. The example telephone numbers described above would be sorted into the following order based on each preliminary score displayed in parenthetical: 512-555-1212 (38); 206-706-2656 (30); 877-438-0863 (20); 425-894-5833 (18); and 412-783-6783 (16).

The preliminary score paring module 512 typically reduces the size of the temporary number pool 110 by removing telephone numbers that fail to meet a threshold preliminary score. For example, if the threshold score required is at least 20, then 425-894-5833 (18) and 412-783-6783 (16) are removed from the list.

In alternative embodiments, only the top specific amount of numbers is kept in the temporary number pool 110, while all others are purged from the temporary number pool 110. For example, in one embodiment, the preliminary score paring module 512 keeps the twenty highest-scored telephone numbers in the temporary telephone number pool 110 and purges the remaining telephone numbers from the temporary telephone number pool 110. Other configurations are possible.

Referring back to FIG. 2, the final score processing module 208 creates a final score for the telephone numbers in the temporary telephone number pool 110.

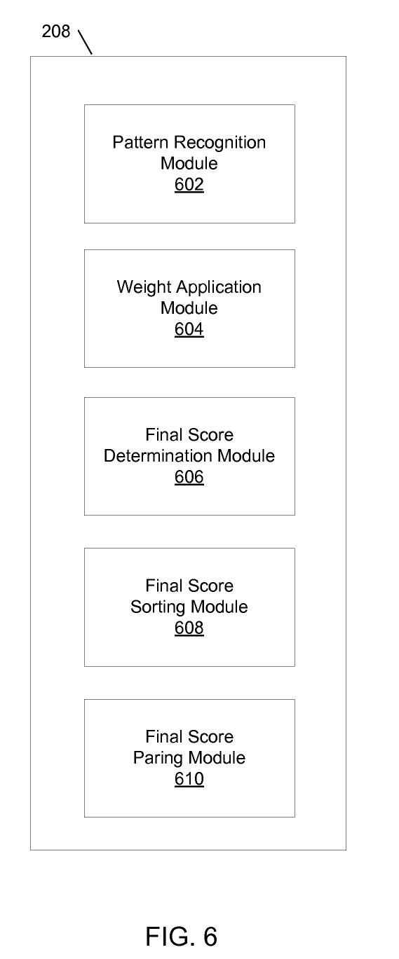

FIG. 6 shows the final score processing module 208 of FIG. 2 in further detail. The final score processing module 208 includes a pattern recognition module 602, a weight application module 604, a final score determination module 606, a final score sorting module 608, and a final score paring module 610.

The pattern recognition module 602 identifies patterns in the telephone numbers of temporary telephone number pool 110. For example, the pattern recognition module 602 searches for specific predefined patterns in the telephone numbers of temporary telephone number pool 110. In some embodiments, there are four patterns that are identified by pattern recognition module 602. In example embodiments, a Boolean value or other tag is used to indicate whether or not a specific telephone number includes each of the following four patterns.

The first pattern identified by the pattern recognition module 602 is where the last two digits of a specific telephone number repeat, such as when the last two digits are “11,” “22,” “33,” etc. This pattern is found in the example telephone number 425-894-5833, where the digit “3” is repeated twice as the last two digits of the telephone number in the 9th and 10th digit positions. The second pattern identified by the pattern recognition module 602 is where the last two digits of a specific telephone number are repeated together elsewhere in the telephone number. This pattern is found in the example telephone number 412-783-6783, where the digits “83” are found in the 9th and 10th positions in the telephone number as well as the 5th and 6th positions of the telephone number. The third pattern identified by the pattern recognition module 602 is where the last two digits of the exchange (the 5th and 6th digits in a 10-digit number) are repeated together elsewhere in the telephone number. This pattern is found in the example telephone number 206-706-2656, where the digits “06” are found in the 5th and 6th positions of the telephone number. Finally, the fourth pattern identified by the pattern recognition module 602 is where the last two digits of the area code (the 2nd and 3rd digits in a 10-digit number) are repeated together elsewhere in the telephone number. This pattern is found in the example telephone number 206-706-2656. In other examples, greater or fewer patterns can be identified by pattern recognition module 602.

The weight application module 604 associates weights with each number based on the pattern recognition analysis performed by the pattern recognition module 602. In the example described above, the weights are assigned as follows: (i) first pattern where the last two digits of a specific telephone number repeat=weight=+10; (ii) second pattern where the last two digits of a specific telephone number are repeated together elsewhere in the telephone number=weight=+7; (iii) third pattern identified where the last two digits of the exchange are repeated together elsewhere in the telephone number=weight=+5; and (iv) fourth pattern where the last two digits of the area code (the 2nd and 3rd digits in a 10-digit number) are repeated together elsewhere in the telephone number=weight=+5. In other examples, other weight schemes can be used.

The final score determination module 606 calculates the final score for each number by adding the scores from the preliminary score determination module 508 and the weight application module 604. For example, for the telephone number 512-555-1212, the final score is calculated as follows:

FINAL SCORE=38+22=60.

The final score sorting module 608 resorts the telephone numbers based on the final scores calculated for each number. The final score paring module 610 typically again reduces the size of the temporary number pool 110 by removing telephone numbers that do not meet a threshold final score. Other configurations are possible.

Those numbers associated with the highest final score represent the most memorable numbers in the list. Those numbers with the lowest final score represent the least memorable numbers in the list.

Referring back to FIG. 2, the post-processing module 210 presents the user with a list of the memorable telephone numbers remaining in the temporary telephone number pool 110.

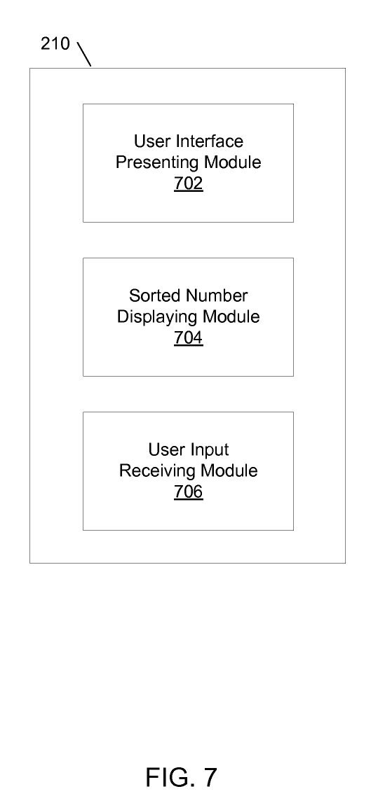

FIG. 7 shows additional details on the post-processing module 210. The post-processing module 210 includes a user interface presenting module 702, a sorted number displaying module 704, and a user input receiving module 706.

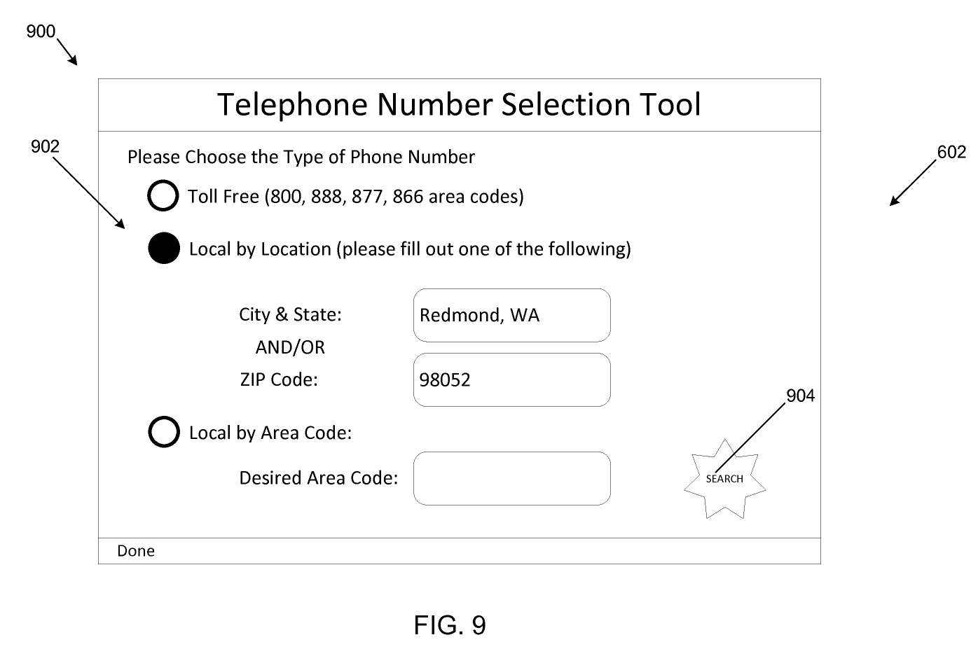

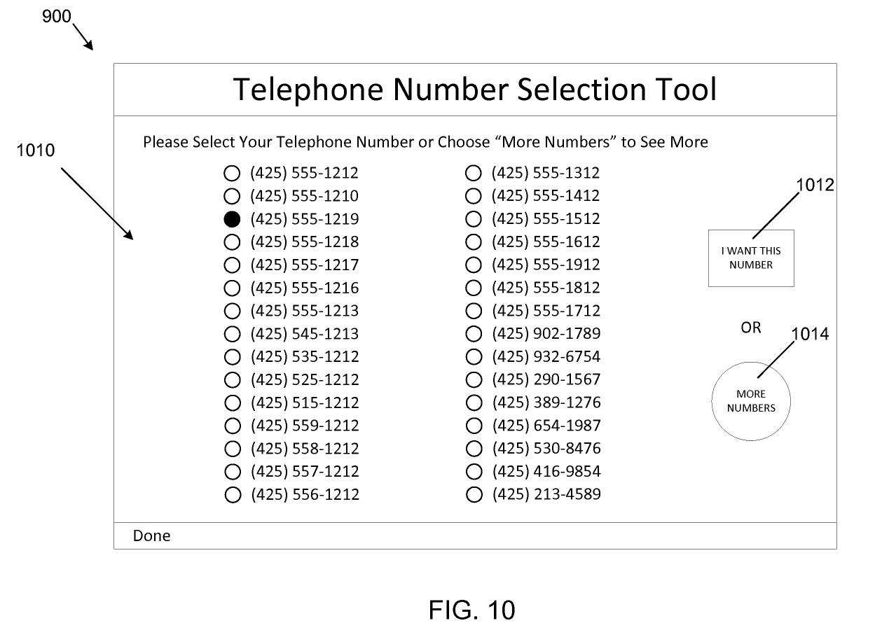

The user interface presenting module 702 prepares a user interface to present to the user of the client 102. In example embodiments, the user interface is a web page formed using known languages and protocols, such as the Hypertext Markup Language (HTML) that is transferred using the Hypertext Transfer Protocol (HTTP). An example of such an interface is shown in FIGS. 9 and 10, which are described below.

The sorted number displaying module 704 assembles the telephone numbers for display on the user interface. In some examples, the sorted number displaying module 704 displays all or a subset of the telephone numbers remaining in the temporary telephone number pool 110 in order of the final score for each telephone number. For example, the telephone numbers can be listed in descending order with the highest final score listed first, and the telephone numbers with the lowest final score listed last. This allows the most memorable telephone numbers to be presented at the top of the list.

The user input receiving module 706 receives input from the user once the list is presented to the user on the client 102. In one example, the user input receiving module 706 is configured to receive the selection of one or more numbers from the list that the user wishes to use. In another example described further below, the user input receiving module 706 is also configured to receive an input from the user requesting that a different pool of numbers be used to create the list.

Referring again to FIG. 2, the master pool and statistical information updating module 212 updates the master telephone number pool 108 and the statistics database 112 based on the user input from the client 102.

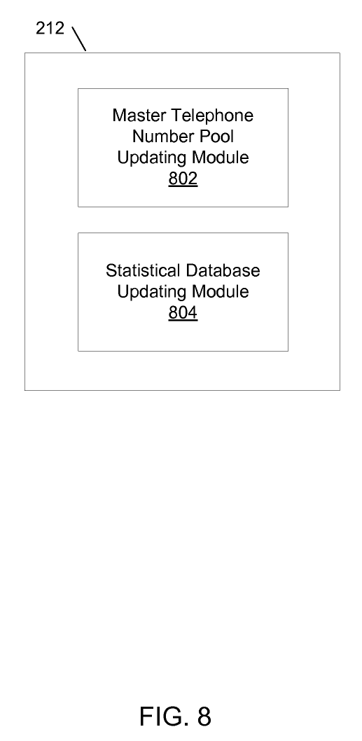

FIG. 8 shows additional details regarding the master pool and statistical information updating module 212. The module 212 includes a master telephone number pool updating module 802 and a statistics database updating module 804.

The master telephone number pool updating module 802 updates the master telephone number pool 108 based on the user input. For example, if the user selects one or more telephone numbers, the user input receiving module 706 notifies the master telephone number pool updating module 802 so that the selected telephone numbers can be removed from the master telephone number pool 108.

The statistics database updating module 804 gathers statistics based on the input from the user of the client 102. For example, statistics database updating module 804 records which, if any, of the numbers are selected by the user, or if the user fails to select a number or requests multiple lists of numbers before selecting a number.

For example, if the user selects one of the highest scored numbers on the list, it can be assumed that the list was satisfactory to the user. If, however, the user selects a lower number, or does not select a number at all, it can be assumed that the lists of numbers were unsatisfactory. Based on the statistics collected by the statistics database updating module 804, the system 100 can determine when the list of numbers in the master telephone number pool 108 have degraded to a point that the amount of memorable numbers have been depleted and a new pool of numbers is needed. For example, as desired memorable numbers are removed from the pool, the pool can degrade to a point at which only a few desired memorable numbers remain. The statistics collected by the database updating module 804 can be used to determine when this has occurred and thereupon signal that a new pool of numbers is needed.

In example embodiments, the master pool can include a large number of available telephone numbers, such as 1,000, 10,000, 20,000, 25,000, or 100,000 available numbers. The temporary pool that is pulled from the master pool can be a subset of the available numbers, such as 1000, 500, 200, or 100 numbers. The final set of available numbers that is presented to the user can be a subset of the temporary pool, such as 200, 100, 50, 30, 25, 20, or 10 telephone numbers. Other amounts of numbers can be used.

If the thresholds that are used during the digital and pattern matching analyses result in a list of numbers that is less than the desired amount to present to the user, the thresholds can be lowered, or additional numbers can be obtained from the master pool and analyzed for inclusion in the list. Other configurations are possible.

Referring now to FIGS. 9 and 10, an example user interface 900 is shown. In this example, the interface is a web page generated by the user input request module 402 of the server 104 and displayed to the user in a web browser application running on the user's client 102. One example of such a browser is the INTERNET EXPLORER® internet browser from Microsoft Corporation. In one example, the SILVERLIGHT™ browser plug-in from Microsoft Corporation is used to render at least a portion of the user interface 900, although other technologies can be used as well.

In example embodiments, the user interface 900 can be provided as part of a process that allows an individual or business to obtain a telephone number. For example, the user interface 900 can be presented as part of the services provided to a business and allow the business to select a telephone number that is memorable.

In FIG. 9, the interface 900 includes a plurality of radio buttons 902 that allow the user to choose which type of telephone number is desired. For example, the radio buttons 902 allow the user to choose between a toll free number, a local number by location, or a local area code. If the location radio button is selected (as shown), the user can enter a city/state and/or zip code. Once the user makes the desired selection, the user selects a search button 904 to send the selection to the user input receipt module 404 on the server 104.

Referring now to FIG. 10, the interface 900 displays a list of the memorable telephone numbers that are available for the user. In the example shown, the interface 900 includes a list 910 of the memorable telephone numbers, with a radio button located next to each number. The list is ordered in descending order from the most memorable number with the highest final score to the least memorable number with the lowest final score. If two or more numbers have the same final score, the numbers are listed in ascending or descending numeric order, or can be listed in an arbitrary order.

The user can select one or more of the numbers in the list by selecting the radio button(s) next to the desired number(s). The user then selects button 1012 to confirm selection of the desired number(s). Alternatively, the user can select the button 1014 to show more numbers if the user does not like any of the numbers listed. If the user selections the button 1014, the system 100 can show other numbers from the temporary pool of numbers or pull a new pool of numbers from the mater pool and calculate new most memorable numbers from the new temporary pool. Numbers that are not selected by the user can be returned to the master pool.

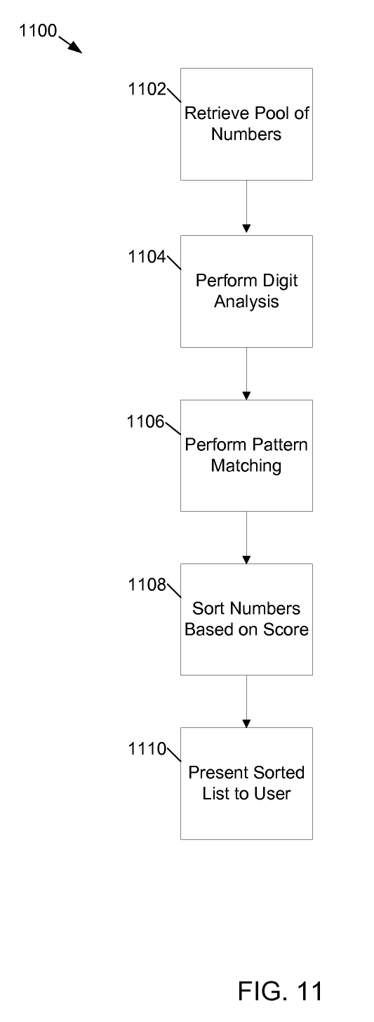

Referring now to FIG. 11, an example computer-implemented method 1100 for selecting a list of memorable numbers is shown.

Initially, at operation 1102, a pool of available numbers is retrieved. Next, at operations 1104 and 1106, the pool of numbers is analyzed to identify memorable numbers. Specifically, in the example shown, the pool is analyzed based on repeating digits in operation 1104, and pattern matching is performed in operation 1106. A score can be associated with each number based on the analysis.

Next, at operation 1108, the numbers in the pool are sorted based on the results of the analysis. For example, the numbers can be listed in descending order based on each number's score. Finally, at operation 1110, the sorted list is presented to the user to allow the user to select one or more numbers.

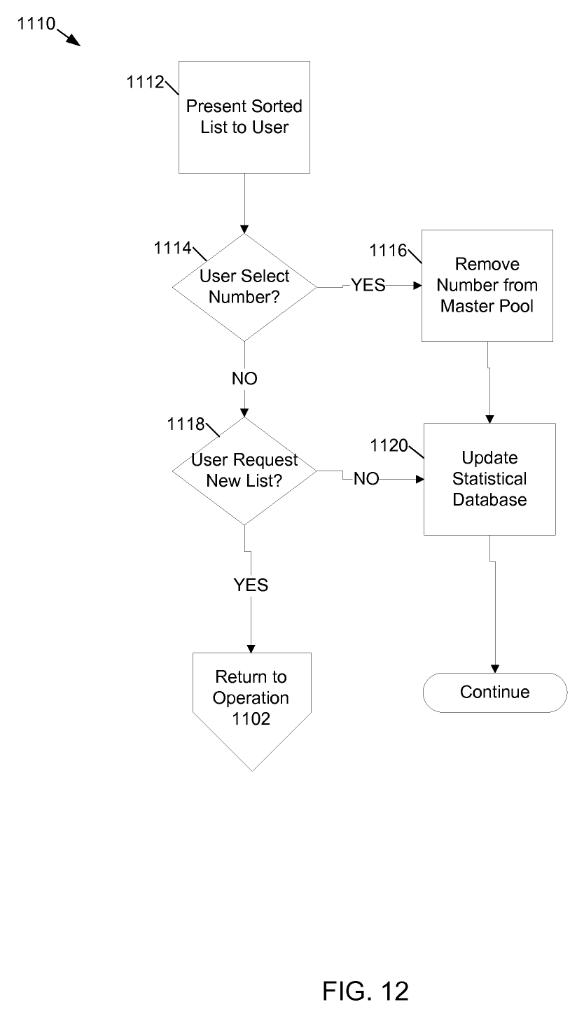

Referring now to FIG. 12, additional details about the presentation of the sorted list to the user at operation 1110 are shown. At operation 1112, the list of sorted numbers is presented to the user. Next, at operation 1114, a determination is made regarding whether or not the user has selected one or more numbers. If so, control is passed to operation 1116, and the selected numbers are removed from the master pool.

Instead, if the user does not select a number, control is passed to operation 1118, and a determination is made regarding whether or not the user has requested a new list of numbers. If so, control is passed back to operation 1102. Alternatively, if the user does not select a number and does not request a new list (or the user has already selected a number), control is passed to operation 1120, and statistical information about the process is captured. For example, information such as the number of lists requested by the user, and/or what was the rank of the number in the list that was selected by the user are captured. This information can be used, for example, to determine the relative “health” of the master pool of numbers so that a new master pool can be obtained when needed.

In the examples described herein, numbers are pulled from a master pool of numbers and then analyzed to develop a sorted list. In another embodiment, all numbers in the master pool can be analyzed and scored. Numbers falling below a threshold value can be removed, thereby leaving only numbers in the master pool having a certain level of memorability. In this embodiment, the numbers from the master pool can be pulled and presented to the user without further analysis. Other configurations are possible.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device, comprising:
a processing unit;
a system memory connected to the processing unit, the system memory comprising instructions that, when executed by the processing unit, cause the processing unit to:
retrieve a pool of telephone numbers;
analyze repeating digits and perform pattern matching for each number in the pool of telephone numbers;
associate a memorability score with one or more of the numbers in the pool of telephone numbers; and
sort the pool of telephone numbers based on the memorability score to create a sorted list of numbers.

2. The computing device of claim 1, wherein the instructions cause the processing unit to present the sorted list of numbers to a user.

3. The computing device of claim 2, wherein the instructions cause the processing unit to receive a selection by the user of one or more of the telephone numbers in the sorted list of numbers.

4. The computing device of claim 1, wherein the sorted list of numbers is assorted in descending order with a telephone with a highest memorability score at a top of the sorted list.

5. The computing device of claim 1, wherein, during the repeating digits analysis, a total number of repeating digits in each number in the pool of telephone numbers is calculated.

6. The computing device of claim 1, wherein, during the pattern matching analysis, a relative pattern of the digits in each number in the pool of telephone numbers is examined.

7. The computing device of claim 1, wherein the pool of numbers is retrieved from a master pool of numbers.

8. The computing device of claim 7, wherein, when the pool of telephone numbers is retrieved, the pool of numbers is stored in a temporary pool of numbers.

9. The computing device of claim 8, wherein the instructions cause the processing unit to remove those numbers with a memorability score below a threshold value.

10. The computing device of claim 1, wherein the instructions cause the processing unit to record statistical information associated with a selection by the user of one or more of the telephone numbers in the sorted list of numbers.

11. A computer-implemented method for identifying memorable numbers in a pool of telephone numbers, the method comprising:
retrieving, at a computing device, a pool of telephone numbers;
analyzing, using the computing device, each number in the pool of telephone numbers to determine whether or not each number is memorable;
associating a score with one or more of the numbers in the pool of telephone numbers, the score indicating a memorability of the numbers; and
sorting, at the computing device, the pool of telephone numbers based on the score to create a sorted list of numbers.

12. The method of claim 11, wherein analyzing further comprises counting repeating digits for each number in the pool of telephone numbers.

13. The method of claim 11, wherein analyzing further comprises performing pattern matching for each number in the pool of telephone numbers.

14. The method of claim 13, wherein performing pattern matching further comprises examining a relative pattern of digits in each number in the pool of telephone numbers.

15. The method of claim 11, further comprising presenting the sorted list of numbers to a user at a remote computing device.

16. The method of claim 11, further comprising receiving, at the computing device, a selection by the user of one or more of the telephone numbers in the sorted list of numbers.

17. The method of claim 11, further comprising retrieving the pool of numbers from a master pool of numbers stored on a second computing device.

18. The method of claim 17, further comprising storing, at the computing device, the pool of telephone numbers in a temporary pool of numbers.

19. The method of claim 18, further comprising removing, at the computing device, those numbers with a score below a threshold value.

20. A computer-implemented method for identifying memorable numbers in a pool of telephone numbers, the method comprising:
retrieving, at a computing device, a pool of telephone numbers from a master pool of numbers;
storing, at the computing device, the pool of telephone numbers in a temporary pool of numbers;
analyzing, using the computing device, each number in the temporary pool of telephone numbers to determine whether or not each number is memorable, including:
counting repeating digits for each number in the pool of telephone numbers; and
performing pattern matching to identify relative patterns of digits in each number in the pool of telephone numbers;
associating a score with each of the numbers in the pool of telephone numbers, with a higher score indicating a greater memorability and a lower score indicating a lesser memorability for the numbers;
removing, at the computing device, those numbers with a score below a threshold value;
sorting, at the computing device, the pool of telephone numbers based on the score for each of the numbers in the pool of telephone numbers to create a sorted list of numbers;
presenting the sorted list of numbers to a user at a remote computing device; and
receiving, at the computing device, a selection by the user of one or more of the telephone numbers in the sorted list of numbers.
